(19) United States
(12) Patent Application Publication
(10) Pub. No.: US 2006/0042323 A1
(43) Pub. Date: Mar. 2, 2006

(54) Method of fabricating a cylindrical optical fiber containing a light interactive film

(75) Inventors: Philipp G. Kornreich, North Syracuse, NY (US); Douglas V. Keller JR., Lafayette, NY (US); James Flattery, Syracuse, NY (US)

Correspondence Address: WALL MARJAMA & BILINSKI, 101 SOUTH SALINA STREET, SUITE 400, SYRACUSE, NY, 13202, US

(73) Assignee: Syracuse University, Syracuse, NY (US)

(21) Appl. No.: 11/034,156

(22) Filed: Jan. 12, 2005

Related U.S. Application Data
(63) Continuation-in-part of application No. 09/934,502, filed on Aug. 22, 2001, now abandoned.
Application No. 09/934,502 is a continuation-in-part of application No. 09/186,189, filed on Nov. 4, 1998, now abandoned.
(60) Provisional application No. 60/090,995, filed on Jun. 29, 1998.

(51) Int. Cl. C03C 25/46

(52) U.S. Cl. 65/431

(57) ABSTRACT

A method of forming a preform which has a glass core surrounded by an outer glass cladding with a coating of a light interactive material disposed between the core and cladding. The method includes providing a glass core having a viscosity which lies within a given preselected temperature range, followed by forming a substantially homogeneous coating of a light interactive material over the surface of the core, with the coating material having a viscosity which is equal to or less than the viscosity of the glass core. A glass cladding is formed over the coated layer, with the cladding glass having a viscosity which overlaps the viscosity of the core glass and a thermal coefficient of expansion compatible with that of the core. The light interactive material is an inorganic material which includes a metal, metal alloy, ferrite, magnetic material and a semiconductor.

### CROSS REFERENCE TO RELATED APPLICATIONS

This is a continuation-in-part of U.S. Ser. No. 09/934,502, filed Aug. 22, 2001 which is a continuation-in-part of U.S. Ser. No. 09/186,189, (now abandoned) filed Nov. 4, 1998 which is a non-provisional of 60/090,995, (now abandoned) filed Jun. 29, 1998 the entirety of each of the above applications which are incorporated herein by reference.

This invention was made with government support under Grant No. F30602-96-C-0172 from the United States Air Force. Rome Laboratories. The government has certain rights in this invention.

### FIELD OF THE INVENTION

This invention relates generally to a method of fabricating optical fibers, and more specifically to a method of fabricating optical fibers with a coating of a light interactive material interposed between the cladding and core of the optical fiber.

### BACKGROUND ART

The technology of fiber optics is constantly changing. These technologies proliferate many technological areas including communications systems, sensors semiconductors, and laser technologies. Newly emerging areas employ fiber optics in a variety of ways. For example, fiber light amplifiers for fiber optic communications, fiber lasers for CD ROM applications, nonlinear fibers for optical switches, and fiber stress sensors in structure represent just a few of the applications of fiber optics.

Related art describes the fabrication of fibers which consist of a glass core covered with a glass tube or cladding that acts as a shield. The core serves to guide the light. Related art also describes coating the glass core with a film which is interposed between the glass core and the glass tube. The coatings used to produce the films can include various inorganic materials such as semiconductors, metals, alloys, magnetic materials, ferrites or ceramics. These films can be employed for a variety of purposes, considering the fact that properties of light traveling in the core can be modified by the presence of a specific coating. The related prior art however, fails to teach exactly how these fibers are to be fabricated when employing a wide variety of coating materials.

The fabrication of the fibers begins with the manufacture of a ““preform””. The “preform” is constructed by forming a coating having a thickness of a few micrometers or less on a glass rod which eventually becomes the core of the optical fiber. The coated rod is then placed inside of a larger diameter glass tube. An alternative method is to coat the inside of the tube. In one case the glass tube is then sealed at one end to create a vacuum in the space between the coated rod and the tube. This assembly is sealed and then heated which causes the glass of the outer tube to collapse onto the coated rod. Additional glass tubes may be collapsed on to this structure until the desired outside diameter of the preform is reached. This assembly is the “preform”. Once the “preform” is constructed, it is then heated to a softening temperature of the glass, and fibers are drawn from the “preform”. However, since the films are relatively thin, difficulty often arises when the fibers are drawn from the ““preform”” as the films tend to fracture and loose their continuity. The related prior art does not teach a reliable method of fabricating fibers which ensures that the continuity of the film layer is maintained as the fibers are drawn from the “preform”. That is, the resulting film material only covers portions of the fiber due to breaks in the material. Moreover, the related art also fails to discuss a method for ensuring that the film layer will remain coherent and homogeneous during the drawing step.

In view of the above, there is a need in the art for a method of fabrication which ensures that the film layer maintains coherency, continuity and homogeneity as fibers are drawn from the “preform”.

### SUMMARY OF THE INVENTION

Accordingly, it is a primary object of the present invention to provide a fabrication method for optical fibers that includes a light interactive film on the core of the fiber, which ensures continuity of the film along the length of the fiber.

Still another object of the present invention is to provide a fabrication method which employs the use of light interactive coatings which adhere homogeneously to the glass rod during the “preform” construction.

Still another object of the present invention is to provide a fabrication method which employs the use of light interactive coatings, such as metals, metal alloys, non-metals, alloys, magnetic materials, semi-conductors, ferrite and other inorganic materials which do not vaporize or decompose when heated to the flow point temperature of the glass.

Still another object of the present invention is to provide a fabrication method which employs the use of light interactive films which flow continuously and homogeneously at the glass rod/glass core interface during the fiber drawing process.

Yet another object of the present invention is to provide a fabrication method which employs the use of light interactive coatings which will form a coherent, continuous film upon completion of the fiber drawing process.

Still another object of the present invention is to provide a fabrication method which results in an optical fiber with a film layer, located between the glass core and the glass shield, which modifies the properties of light traveling in the core.

Another object of the present invention is to provide a fabrication method which employs the use of light interactive coatings in which the viscosity of the particular coating is less than the viscosity of the particular glass at the glass flow point temperature thereby allowing the coating to flow during the fiber drawing process.

Another object of the present invention is to provide a fabrication method which allows a partial coating of the core with a film layer. In some applications, it is desired to have only a small fraction of the core covered with a light interactive film, yet that partial coating must be continuous along the optical fiber.

Another object of this present invention is to provide a fabrication method where the glass cladding and glass core are of a different composition.

Another object of the present invention is to provide a secondary inorganic coating over the coated “preform” core previously coated with a layer of light interactive material. The object is to prevent a low melting point coating material from dewetting the core at the “preform” collapse temperature.

These and other objects are accomplished by the method and resulting product of the present invention. The present invention is based upon the observations that during the fiber pulling process, the pressure in the glass can vary by a factor of several thousand from the point where the preform starts to the narrow to the point where the fiber diameter is reached. Consequently, in order for the film layer to maintain continuity, the plaso-viscosity properties of the coating material and the glass must be matched. If the film is pushed along (deformed) by the neighboring glass, which is softer than the film, the front edge of the film is likely to dig in. As a result, the glass might stretch the film beyond its breaking point, thereby tearing the film. Thus, the glass cannot be heated too much or it will be too soft during the drawing process. This makes it necessary to pull the fiber at the lowest temperature possible. Consequently, it is beneficial to conduct the fiber pulling process at temperatures where the film material is in a solid-liquid or liquid phase at the glass softening point. This provides the best assurance that the film will be soft and ductal so that it will deform smoothly when pulled.

The glass core for the present invention is selected such that its flow range lies within a preselected temperature range and is compatible with the cladding glass. Although the flow range depends upon the type of glass, it generally lies between about 600° C. and 1500° C. The glass core material can be selected from any suitable glass, depending upon the application of the fiber that is produced. For example suitable glasses include, Pyrex, pure fused silica, and aluminosilicate glasses. The diameter of the glass core in the preform can also vary depending upon the application; however, they typically have an outside diameter of about 0.1 cm.

The coating material is placed over the surface of the core, and eventually forms the film. The coating materials serves to modify the properties of the light traveling in the core. An appropriate coating material must remain coherent and continuous when drawn into the fiber, despite the fact that the film must be relatively thin. For instance, most films have a final thickness of 10 nanometers for less. Consequently, the material selected for the coating must have a flow point which lies below the flow range for the glass. That is, the viscosity of the specific coating selected must match or be less than the viscosity of the glass at the flow point temperature of the glass core material. To accomplish this, the material of the film is chosen which has a viscosity less than the core and cladding glass at the “preform” collapsing temperature and the fiber drawing temperature. Moreover, the coating material must be one that does not break down chemically, vaporize or adversely react when it comes into contact with the glass at this fabrication temperature. For example, Indium metal has a melting point of 156.2° C., yet is not significantly vaporized, nor does it react with glass at the glass flow points below 900° C. It should also be noted that the coating must also adhere well to the glass since it must remain in place homogeneously throughout the preform construction.

The coating material can be any suitable inorganic material such as either an alloy, a metal, non-metal, ceramic, ferrite, magnetic material or semiconductor material, and can be any species of one of those genuses. These coating materials should preferably have viscosities less than the viscosity of the core/cladding glass at the softening point of glass, and be capable of modifying the properties of light traveling in the core. In addition a number of multi component semiconductor systems meet the viscosity requirements. The resulting film serves as an interface between the core and the outer glass cladding. The film is substantially uniform over the entire surface of the glass core.

The glass cladding is formed over the interfacial film layer. The glass cladding material can be selected from any standard glass as well, such as those used for the core, depending upon the application of the fiber that is produced; however, the glass cladding must have a flow range which overlaps the flow range of the glass core material. Usually the core glass has a higher index of refraction than the cladding glass and similar thermal expansion coefficients.

Three suitable pairings of core/cladding glass combinations which can be used in the present invention and their respective properties are tabulated below.

TABLE

| | | | | |
|---|---|---|---|---|
| | | Thermal | | |
| | | Expansion | Softening | Refractive |
| Type of Glass | Type | Coeff. | point C. | Index |

Example #1

| | | | | |
|---|---|---|---|---|
| Core Rod | Borosilicate | 5.15E−06 | 702 | 1.487 |
| Glass | | | | |
| Code 7056 | | | | |
| Cladding | Borosilicate | 4.60E−06 | 708 | 1.484 |
| Glass | | | | |
| Code 7052 | | | | |

Example #2

| | | | | |
|---|---|---|---|---|
| Core Rod | Borosilicate | 3.67E−06 | 780 | 1.476 |
| Glass | | | | |
| Code 7251 | | | | |
| Cladding | Borosilicate | 3.40E−06 | 780 | 1.473 |
| Glass | | | | |
| Code 7760 | | | | |

Example #3

| | | | | |
|---|---|---|---|---|
| Core Rod | Borosilicate | 4.60E−06 | 712 | 1.484 |
| Glass | | | | |
| Code 7052 | | | | |
| Cladding | Borosilicate | 4.75E−06 | 702 | 1.480 |
| Glass | | | | |
| Code 7040 | | | | |

All of the above glasses are available from Corning under their respective code numbers listed in the table.

### BRIEF DESCRIPTION OF THE DRAWING

For a fuller understanding of the nature and objects of the invention, reference should be made to the following detailed description of a preferred mode of practicing the invention, read in connection with the accompanying drawings, in which:

FIG. 1 is a partially broken away perspective view illustrating a method for forming a preform of the present invention.

FIG. 2 is a side elevational view of a conventional drawing tower suitable for drawing a fiber made according to the present invention.

FIG. 3 is a side sectional view illustrating a method of making a preform of the present invention.

FIG. 4 is a side sectional view of the method illustrated in FIG. 3 with vacuum means and a traveling furnace.

FIG. 5 illustrates the transmission spectrum of an AlCu alloy strip fiber of the present invention.

FIG. 6 illustrates the transmission spectrum for the fiber preform of a CdTe film.

FIG. 7 is a perspective view of a dual fiber made in accordance with the present invention.

### DETAILED DESCRIPTION OF THE INVENTION

To achieve the foregoing and other objectives, a method of fabricating a “preform” according to the present invention is as follows. The method of fabrication results in a “preform” which consists of a glass core, a coating which eventually forms a thin film on the glass core, and a glass cladding which surrounds both the film and the core. This glass cladding acts as a shield, whereas the glass core serves to guide the light. The film serves to modify the properties of the light traveling within the core. The fibers are drawn from this “preform”. A typical optical fiber has an outside diameter of about 125 micrometers, while the outside diameter of the core is about 10 micrometers.

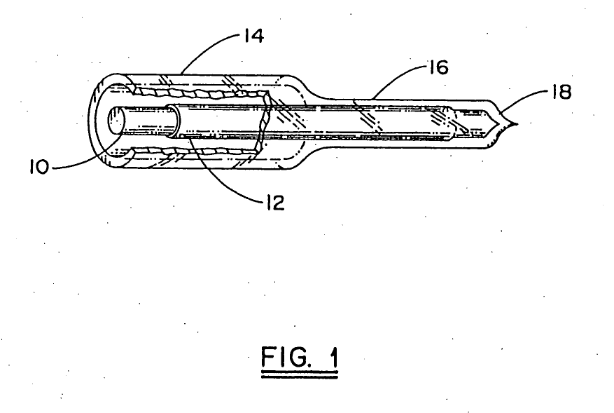

In one embodiment, the preform can be made by forming a coating of semiconductor material 12 over a core rod 10 inside an evacuated glass tube as illustrated in FIG. 1. The tube is then sealed under vacuum to form an ampoule. In another embodiment the core rod is coated in a vacuum chamber and then inserted into a glass tube connected to the vacuum system. The tube is then sealed under vacuum to form an ampoule. The tube is then collapsed unto the coated core rod as shown at 16 in the drawing.

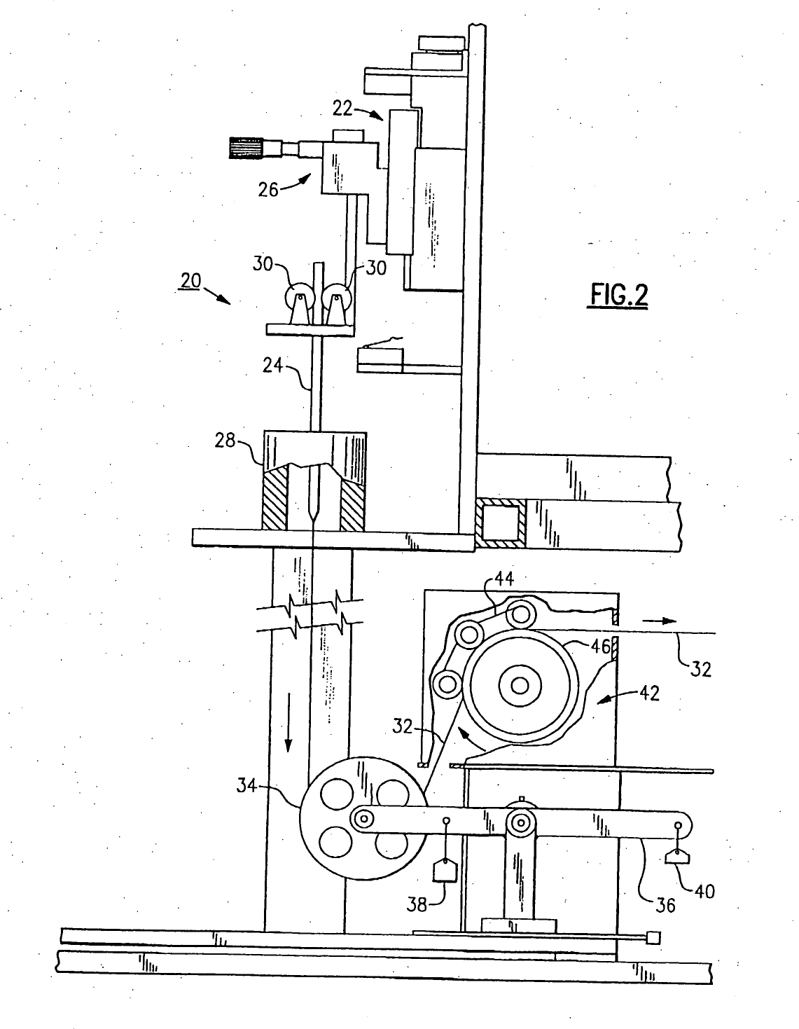

The fiber is drawn from the preform by any modified fiber drawing tower apparatus known to the art. FIG. 2 illustrates a fiber drawing tower 20 suitable for use in making fibers of present invention.

The top of the fiber drawing tower includes a motorized translation stage 22 which lowers the preform 24 at a rate governed by the speed at which the fiber is drawn. The horizontal position of the preform can be adjusted with an x-y translation stage 26 to align it with the center of the furnace 28. The preform is held by a centering chuck 30. The furnace heats the preform so that a fiber 32 can be drawn from it.

The fiber is drawn to the bottom of the fiber drawing tower emerging from the furnace 28 passes over pulley 34 that is mounted on a lever arm 36. A weight 38 provides the required tension for the fiber and preform during the drawing process so that the core and cladding glass of the preform will smoothly extrude the optically active material layer. There is a counterbalancing weight 40 at the opposite end of the lever arm to balance the weight of the pulley. The capstan 42 pulls the fiber 32 between a belt 44 and stainless steel wheel 46.

In a preferred embodiment of the present invention, the preform is made in the absence of contact with air. It has been discovered that processing in air results in oxidation of the coating of light interactive material rendering it inoperable and/or unsuitable for use in optical and/or amplification applications. It is therefore, highly preferred that in the manufacture of the perform, that the formation and sealing of the light interactive film be carried out under vacuum conditions. A vacuum of about 1×10⁻⁶ Torr has been found to be satisfactory. Typically a range of about 1×10⁻⁵ to 1×10⁻¹⁰ Torr can be used. For example, preforms made using CdTe light interactive coatings which were exposed to air during their processing exhibited no useful properties, while equivalent CdTe light interactive coated preforms made under vacuum conditions exhibited useful properties.

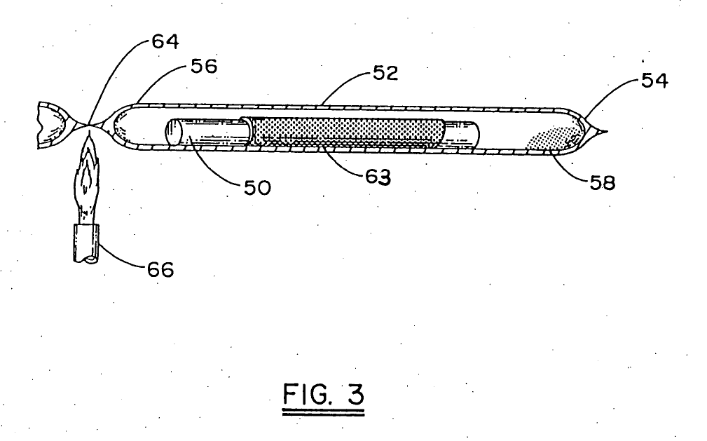

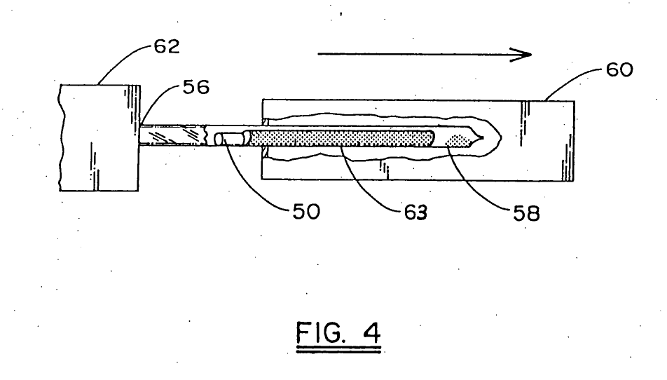

In one embodiment of the present invention, as illustrated in FIGS. 3 and 4, the “preform” is fabricated by placing a 0.1×11 cm glass rod 50 into a 0.2 ID×18 cm glass tube 52 which is sealed at one end 54 and evacuated from the other end. The sealed tube contains a few milligrams of a light interactive material 58 placed at the sealed end of the tube (See FIG. 3). Coating of the rod with the light interactive material prior to sealing is typically achieved by vacuum deposition using a traveling tube furnace 60 (FIG. 4) heated to the vapor point of the material. The furnace is moved from one end of the tube starting from that end nearest the vacuum pump 62, to the opposite end of the tube nearest the material source (See FIG. 4). Because it is too hot inside the furnace for material to deposit on either the rod or the inside of the tube, deposition occurs where the tube emerges from the furnace. Thus the outside of the rod or inside of the tube is coated as the furnace moves. The furnace is of such length to envelope the entire rod and material source throughout deposition. The furnace temperature also lies below the glass tube collapse point. After completing the deposition of the film layer 63, the ampoule is sealed at 64 the end near the vacuum system using a burner 66 (See FIG. 3). The ampoule is then removed from the furnace and allowed to cool to room temperature. The section containing the powder is then pinched off. The advantage of this method of deposition is that the film never comes in contact with the air. However, this method, which employs a heater to evaporate the coating material, can only be used for materials that will evaporate at temperature below which the ampoule will collapse, otherwise, alternative coating methods must be employed. For example, an optical deposition system that uses light with wavelength in the visible range can be used to evaporate the coating without heating the ampoule glass. This method of evaporation is useful with semiconductors since glass is transparent to light, and the semiconductors absorb the light. Specifically, an argon laser operating at 2.25 W can be used to evaporate a Ge semiconductor in a sealed, evacuated Pyrex ampoule.

After the optically interactive layer is deposited in a vacuum on either the glass core rod or the inside of the glass tube surrounding the core rod the glass tube is pinched off so as to seal it and to maintain the vacuum in the tube. At this point the core rod has a smaller diameter than the inside diameter of the tube. The sealed glass tube containing the core rod and optically interactive coating is called an ampoule.

Regardless of the deposition method, the ampoule is placed in a boat on a bed of a low melting point metal such as Sn or solder. The boat is placed in a chamber that can be pressurized. The chamber containing the boat is pressurized and placed in a preheat furnace where the low melting point metal melts. The ampoule floats on the molten metal.

The pressure chamber is, next, moved into a high temperature furnace where the pressure chamber and thus the ampoule are heated to a temperature where the glass tube will collapse onto the core rod trapping the optically interactive coating between them. The liquid metal on which the ampoule floats provides uniform heating during collapse.

The pressure chamber is moved back to the preheat furnace where the temperature is sufficiently low for the glass to harden while still floating on the liquid metal. The liquid metal on which the ampoule floats provides uniform heating and a uniform mechanical support during the solidification of the glass. After the collapsed ampoule has had enough time to harden the pressure chamber is pulled out of the furnace, the pressure is reduced and it is allowed to cool so it can be opened and the collapsed ampoule can be removed.

The ampoule can be inserted into another glass tube. This second glass tube is evacuated and sealed. The collapsing process is than repeated with the second glass tube. If necessary more glass tubes are collapsed onto that second glass tube in order to obtain the desired outside diameter. The resulting structure is the fiber preform. The fibers are then pulled from this preform.

During the fiber pulling process the pressure in the glass can vary by a factor of several thousand from the point where the preform begins to flow to the narrow point where the fiber diameter is reached. Consequently, in order for the film layer to maintain continuity, the plaso-viscosity properties of the coating material and the glass must be matched. If the film is pushed along (deformed) by the neighboring glass, which is softer than the film, the front edge of the film is likely to dig in. As a result, the glass might stretch the film beyond its breaking point, thereby tearing the film. Thus, the glass cannot be heated too much or it will be too soft during the drawing process. This makes it necessary to pull the fiber at the lowest temperature possible. The coating material should preferably have a viscosity less than the viscosity of the glass. Consequently, it is beneficial to conduct the fiber pulling process at temperatures where the film material that is in a liquid or solid-liquid phase at the glass softening point. This provides the best assurance that the film will be soft and malleable so that it will deform smoothly when pulled.

In the preferred embodiment the core is cylindrical in shape. The glass core is selected such that its flow range lies within a preselected temperature range. Although the flow range depends upon the type of glass, it generally lies between 600° C. and 1500° C. The glass core material can be selected from any glass, depending upon the application of the fiber that is produced. For example, Pyrex, pure fused silica, and aluminosilicate glasses can be used. It is necessary for the fibers to have cores through which only a single mode propagates The diameter of the glass core can also vary depending upon the application; however, they typically have an outside diameter of about 0.1 cm.

The coating material is placed over the surface of the core, and eventually forms the film. The coating materials serves to modify the properties of the light traveling in the core. An appropriate coating material must remain coherent and continuous when drawn into the fiber, despite the fact that the film must be relatively thin. For example, most films have a final thickness of about 10 nanometers or less.

Consequently, the material selected for the coating must have a flow point which lies below the flow range for the glass. That is, the viscosity of the specific coating selected must be equal to or preferably less than the viscosity of the glass at the flow point temperature of the glass core material. In the event that the film material has a melting point below the softening point of the glass and a characteristic of dewetting glass at the melting point, the material coating on the glass rod can be coated with a second material with a higher melting point, e.g. powdered glass, which will hold the light interactive material in place during “preform” collapse.

Moreover, the coating material must be one that does not break down, vaporize or react when it comes into contact with the glass. For example, Indium metal has a melting point of 156.2° C., and is not significantly vaporized, nor does it react with glass at glass flow points below 900° C. It should also be noted that the coating must adhere well to the glass since it must remain in place homogeneously throughout the preform construction. Indium dewets glass at the collapse temperature; however, indium coating covered with a powdered glass mix at temperature below its melting point will survive the cladding collapse process without dewetting the core.

The coating material can be any suitable inorganic material such as a metal or metal alloy, ferrite, magnetic or semiconductor material, and can be any species of one of those genuses. These coating materials have flow points below the softening point of glass, and are capable of modifying the properties of light traveling in the core. In addition any multi component semiconductor systems which meet the viscosity requirements can be used in the present invention. More specifically, InSb and GaSb systems are continuous solids and have a significant liquid/solid phase within the 500 to 800° C. temperature range. In this range the viscosity of the semiconductor is adequate when the glass flow range lies in the same region.

The resulting film serves as an interface between the core and the glass tube. The film is substantially uniform over the surface of the glass core.

The glass cladding is formed over said interfacial film layer. The glass cladding material can be selected from any standard glass, depending upon the application of the fiber that is produced, however, the glass cladding must have a flow range which overlaps the flow range of the glass core material. In one embodiment, the index of refraction of the core was slightly higher than the index of refraction of the cladding.

The following example illustrate an embodiment of the present invention.

### EXAMPLE

In one embodiment of the invention an AlCu alloy was used as the coating layer. Cu has a melting point of 1086° C., while Al has a melting point of 660° C. Consequently, the melting point of AlCu can be adjusted by selecting the appropriate Al and Cu composition. Appropriate amounts of Cu and Al are selected to yield the desired alloy. AlCu alloys with melting points ranging from 540° C. to 1084° C. can be fabricated.

The alloy was vapor deposited on a Corning 7740 glass rod. This rod has a softening point of about 750° C. Consequently, it was necessary to use an alloy which contained between 35 and 100 percent aluminum. Preferably, due to a chemical reaction between the glass and aluminum at the softening point of the glass, higher copper concentrations should be used to reduce evaporation of the alloy. Moreover, alloys that are in the liquid-solid phase are generally acceptable since their viscosity would allow the metal to flow during the fiber drawing process.

In a specific embodiment, a layer of the AlCu coating material was vacuum deposited on a 1 mm diameter type 7720 Corning glass rod. The AlCu alloy contained about 62% Cu and 38% Al by weight. The melting point of the alloy was about 680° C. The rod is inserted into a type 7052 Corning glass tube that was closed at one end. The glass tube has a 3 mm outside diameter, and a 1.8 mm inside diameter. The tube is then evacuated to 10⁻⁸ Torr., heated at about 250° C. for two hours, and sealed at the vacuum pump end to form a closed ampoule tube. The ampoule tube is then collapsed. Other tubes are sequentially collapsed on to the collapsed ampoule. This resulted in the formation of a 8.3 mm O.D. preform. In an alternative method of fabrication, the ampoule can be collapsed under an external pressure at about 650° C., and two Glass tubes can be sequentially collapsed onto the collapsed ampoule to form the “preform”. Additional tubing layers could be employed to achieve a necessary “preform” diameter.

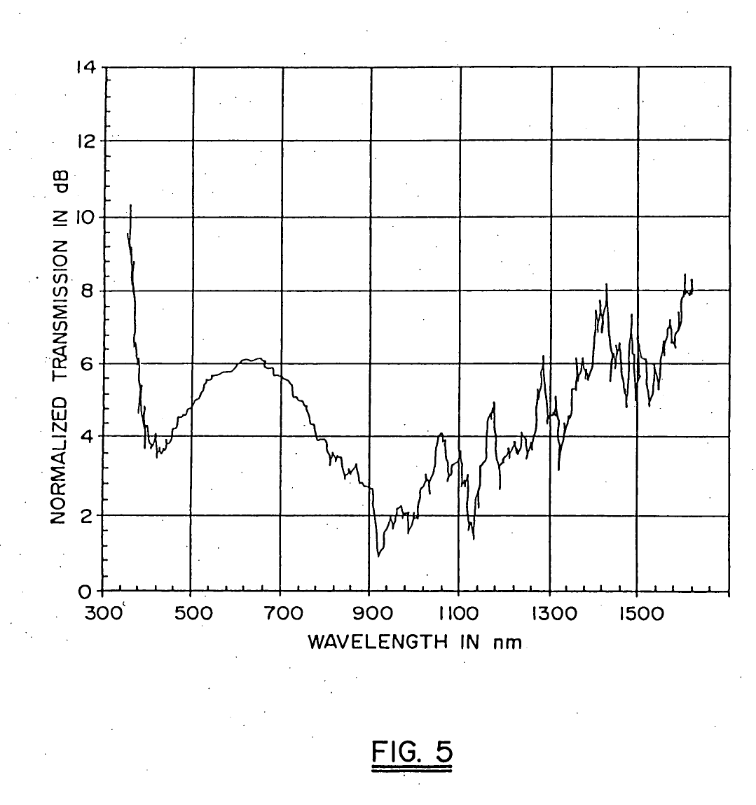

The transmission spectrum of the AlCu alloy strip fibers described above were measured at room temperature using an unpolarized white light source. The data is shown in FIG. 5. Fiber samples about 30 cm long were used. Note the resonances at 449 nm, 935 nm, and 1140 nm. These resonances correspond to optical frequencies of 6.677×10¹⁴ Hz, of 3.206×10¹⁴ Hz, and of 2.630×10¹⁴ Hz respectively. One application for this structure is the use as high dispersion fiber for pulse shape correction.

Cylindrical fibers with a light interactive metallic film surrounding a cylindrical core can be used for dispersion correction, and light pulse reshaping. The thin, about 5 nm thick, metal film has entirely different properties than bulk metal. The thin metal layers have the properties of a dielectric layer with an index of refraction of about 90. This, results in Fabrey-Perot resonances in the metal layer. At light frequencies near these resonant frequencies the fibers exhibit very large dispersion properties. Both positive and negative dispersion can be achieved depending on which side of the resonant frequency the fiber is operated. At these resonances the fibers are dissipative. However, the dispersion maxima occur at light frequencies to either side of the resonant frequency where the losses are minimal. The resonant frequencies depend on the thickness of the metal film. Thus, by controlling the metal film thickness, the light frequencies at which the high dispersion with the appropriate sign occurs can be determined. These to are inexpensive to fabricate since a very large number of high dispersion fiber sections can be made from a single preform.

Another sample was made with a CdTe semiconductor at the core cladding boundary. These fibers had a core diameter of 10 μm and a smooth uniform semiconductor layer. Since the core diameter is near single mode the interaction is much stronger. Also this transmission spectrum exhibited a blue shift due to the quantum size effect of the very thin, approximately 5 nm thick, semiconductor layer.

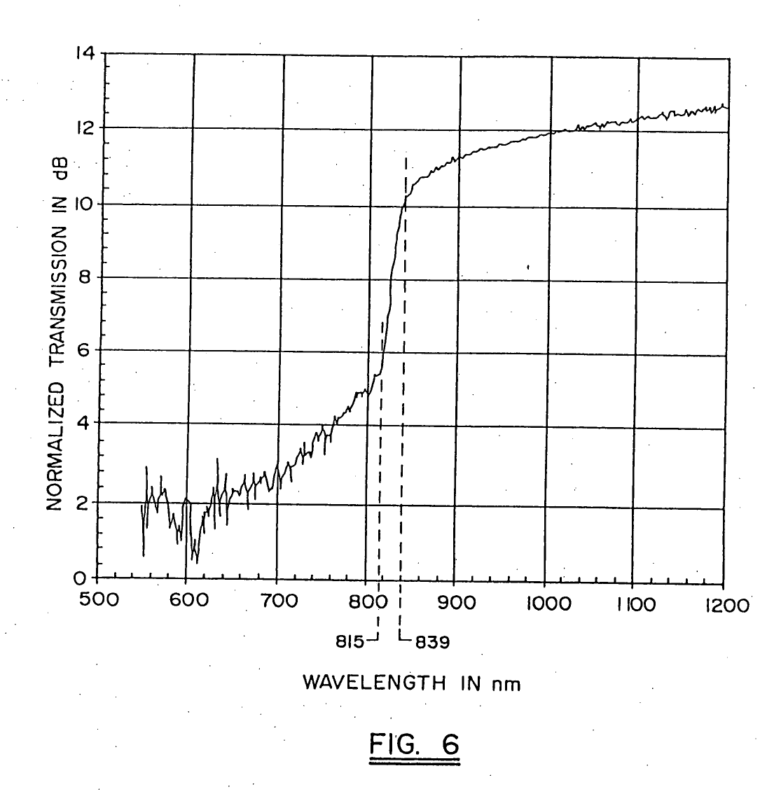

We, first, measured the transmission spectrum of the fiber preform. The fiber preform exhibits a step at a wavelength of 827 nm in the transmission spectrum as shown in FIG. 6. This is in agreement with its value in bulk crystalline CdTe. The step is relatively sharp having a width of only 1.7 kT. measurements were performed at room temperature.

The primary application of the semiconductor cylinder fiber (SCF) is as a fiber light amplifier (FLA). It has the following advantages over present doped glass FLAs: it can be pumped with broad spectral light such as light from a light emitting diode (LED). Since the semiconductor cylinder fiber light amplifiers (SCFLA) are only about 5 mm long they can be pumped from the side rather than requiring input and output couplers, and a laser to focus light into the single mode core of the FLA. They are inexpensive to fabricate since a very large number of SCFLAs can be made from a single preform. Since each device is only about a few mm long 200,000 SCFLAs can be obtained from 1 km of fiber run. This is similar to the semiconductor integrated circuit fabrication process where a large number of devices can be made form a single wafer.

The light which is made up of photons interacts with the electrons and atoms of the material. In amplification, the semiconductor is illuminated (pumped) with a light that has a higher energy than the (signal) light that is to be amplified. The high energy light interacts with the electrons causing them to go to a higher energy state. The signal light also interacts with the electrons causing electrons to lose energy and emit additional signal light protons, that is, amplify the incoming light.

In another application, in Faraday Rotation, the light (photons) interacts with the spin angular momentum of the electrons in the material to rotate the polarization of the light.

Another application for the semiconductor film is in nonlinear fiber. Fibers with nonlinear characteristics can be used in high speed optically activated optical switches. The SCFs have much larger nonlinear characteristic than conventional fibers.

Another embodiment of a useful fiber configuration are fibers with two cores. The preforms for the two coated core fibers are fabricated as follows:

In one embodiment, two individual preforms are constructed. Each preform consists of two 7440 Pyrex glass tubes that are successively collapsed onto a type 3320 2.1 mm diameter glass rod. This forms two 6.3 mm diameter preforms. The preforms are mounted next to each other on a wooden block. The wood block is clamped to the sliding platform of a glass cutter. Two glass cutting wheels forming a dado cutter are mounted on the shaft of the glass cutter. The preform and wood support are moved into the path of the dado cutter. The stacked glass cutting wheels cut a dado between the two preforms. The resulting flat surface of each preform can be polished if necessary. The flat surfaces of the two “D” shaped preforms are coated with a suspension of type 7440 glass powder in an organic binder. The flat surfaces of the “D” shaped preform are pressed together and heated. This fuses the two “D” shaped preforms into a single two core preform. A fiber is then drawn form this preform. The spacing between cores can readily be adjusted in the dado cutting process. An “Isolator” can be fabricated by surrounding both cores with a poled non absorbing magnetic material.

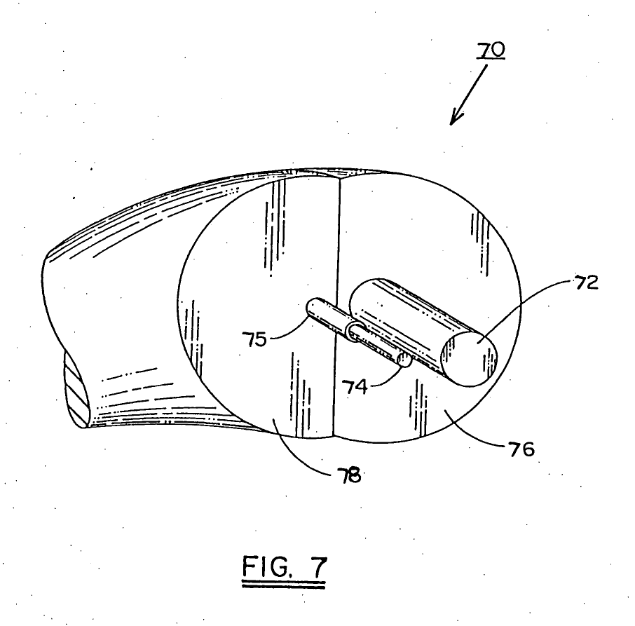

A perspective view of the resulting fiber 70 is illustrated in FIG. 7 in which the dual cores 72 and 74 are surrounded by their respective outer claddings 76 and 78. Core 74 contains a coating 75 of light interactive material, and large uncoated core 72 functions to supply pump light to amplifying core 74-75.

In a further embodiment, a composite structure can be made by depositing an In layer on the glass rod followed by a thicker alloy layer, followed by another In covering layer.

The fibers can be smoothly drawn from these “preforms”. In all cases the fibers have a continuous interfacial layer.

While the present invention has been particularly shown and described with reference to the preferred mode as illustrated in the drawing, it will be understood by one skilled in the art that various changes in detail may be effected therein without departing from the spirit and scope of the invention as defined by the claims. Accordingly, the drawing and description are to be regarded as illustrative in nature, and not as restrictive.

We claim:

1. A method of forming an optical fiber which is suitable for use as an amplifier from a preform having a glass core surrounded by an outer glass cladding with a coating of material between the core and cladding which strongly interacts with the light in the core to affect either high dispersion, absorption saturation, amplification, Faraday rotation or other similar effects of the said light, said method comprising:
(a) providing a preform having a glass core, a substantially homogeneous coating of a light interactive material over said glass core and a glass cladding over said coating of said light interactive material, with said glasses having an overlapping flow range and said coating material having a flow point which lies below the flow range of said glasses with said flow range being in the range of about 600-1500° C.; and wherein the coating of said light interactive material of said perform has been made in the absence of air or oxygen and
(b) heating said preform to an elevated temperature and drawing a fiber from said preform at the flow temperature of said glasses, whereby a fiber is formed having a substantially continuous film of light interactive material formed between said core and cladding throughout the entire length of the fiber.

2. The method of claim 1 in which the light interactive coating comprises an inorganic material.

3. The method of claim 1 is in which the light interactive material is an inorganic material selected from the group consisting of a metal, metal alloy, ceramic, ferrite, magnetic material and a semiconductor.

4. The method of claim 1 in which the light interactive material comprises a metal or a metal alloy.

5. The method of claim 1 in which the light interactive material comprises an AlCu alloy.

6. The method of claim 1 in which the perform has been made under vacuum conditions.

7. A method of forming an optical fiber which is suitable for use as an amplifier from a preform having a glass core surrounded by an outer glass cladding with a coating of semiconductor material between the core and cladding which strongly interacts with the light in the core to affect either high dispersion, absorption saturation, amplification, Faraday rotation or other similar effects of the said light, said method comprising:
(a) providing a preform having a glass core, a substantially homogeneous coating of a light interactive semiconductor material over said glass core and a glass cladding over said coating of said light interactive semiconductor material, with said glasses having an overlapping flow range and said coating material having a flow point which lies below the flow range of said glasses with said flow range being in the range of about 600-1500° C.; and wherein the coating of said light interactive material of said perform has been made in the absence of air or oxygen and
(b) heating said preform to an elevated temperature and drawing a fiber from said preform at the flow temperature of said glasses, whereby a fiber is formed having a substantially continuous film of light interactive semiconductor material formed between said core and cladding throughout the entire length of the fiber.

8. The method of claim 7 in which the preform has been made under vacuum conditions.
